(19) United States
(12) Patent Application Publication
(10) Pub. No.: US 2006/0128310 A1
(43) Pub. Date: Jun. 15, 2006

(54) Transmit/receive compensation in smart antenna systems

(76) Inventor: Michael Leabman, San Ramon, CA (US)

Correspondence Address: WINSTON IP, 2 PARK PLAZA SUITE 510, IRVINE, CA, 92614, US

(21) Appl. No.: 11/011,485

(22) Filed: Dec. 14, 2004

(51) Int. Cl. H04B 1/00; H04B 15/00

(52) U.S. Cl. 455/63.1

(57) ABSTRACT

A radio communication system includes multiple antennas and a processor coupled to the multiple antennas. The processor includes a probeless transmit/receive compensation component enabling the radio communication system to compensate for variations in transmit and receive paths while transmitting a signal. A transmit/receive compensation method includes, for each antenna in an antenna array, transmitting a known signal using the antenna while receive the transmitted signal using the other antennas in the antenna array, and calculating transmit/receive compensation based on the ratios between received signals and transmitted signals.

### TECHNICAL FIELD

This disclosure is directed to a radio communication system and, more particularly, to compensation techniques for use in smart antenna systems.

### BACKGROUND

In radio communication systems, such as, for example, mobile telephone systems and wireless networks, signals are transmitted and received by one or more antennas. These signals propagate through communication channels that are affected by a variety of factors including: atmosphere, man-made structures, terrain, and radio interference. System performance may be impaired by interference from a number of sources.

Multipath interference occurs when a signal propagates, bouncing off objects and causing multiple signals to arrive at the receiver. The multiple signals that are received interfere with one another because of differences in phase and amplitude. For example, a transmitted signal may reach a receiver by both a line-of-sight path and a path reflected off a building. The reflected signal travels over a longer distance, causing further attenuation and a change in phase. In this example, the two received signals may interfere with one another, degrading link quality.

In addition, transmissions at the signal frequency by other radios may interfere with signal reception as well as a variety of spurious transmissions. Interference may be caused by unrelated devices, or may be a result of planned frequency reuse. In a communications network spread over a geographical area, it is common to reuse frequencies. Though frequency reuse is typically engineered to minimize harmful interference, some interference may result.

In many cases, a desired signal is received from a direction other than that of interfering signals. Spatial processing techniques, such as, for example, beamforming and space-time coding, may be employed to modify transmission and/or reception characteristics of a radio transceiver to mitigate the effects of harmful interference.

An antenna has radiation characteristics affecting overall system capacity and performance. For example, an omni-directional antenna radiates or receives signals in any direction with similar performance. Consequently, an omni-directional antenna, by itself, is susceptible to the kinds of harmful interference discussed above.

When an antenna array is used (i.e., an antenna systems having multiple antenna elements arranged in any fashion), spatial processing techniques may be employed to vary the gain and phase characteristics of signals radiated or received by each of the antenna elements to form a radiation pattern designed to attenuate interference and to improve signal gain in one or more directions. This allows increased capacity as multiple radios may transmit on the same or similar frequencies with reduced likelihood of interference and multipath fading, and improved reliability with increased gain in the direction of each signal of interest.

### SUMMARY

In one general aspect, a radio communication system includes multiple antennas and a processor coupled to the multiple antennas. The processor includes a probeless transmit/receive compensation component enabling the radio communication system to compensate for variations in transmit and receive paths while transmitting a signal.

In some implementations, the multiple antennas form an antenna array. The processor may be implemented as a digital signal processor with each of the multiple antennas coupled to the processor by a transmit path that is independent from the transmit path used by other antennas and by a receive path that is independent from the receive path used by other antennas.

In an exemplary implementation, the probeless transmit/receive compensation component of the processor is operable to calculate a set of complex weights to compensate for variations in transmit and receive paths by periodically iterating through each of the multiple antennas, transmitting a known signal using one of the multiple antennas, while receiving the transmitted known signal using the remaining antennas; and calculating a set of compensation parameters based on received signals, such as, for example, orthogonal frequency division multiplexing (OFDM) signals. When transmitting OFDM signals having multiple tones, the transmit/receive compensation component of the processor may be configured to calculate a separate set of complex weights for groups of OFDM tones.

In another general aspect, a radio includes a signal processing unit, and at least two radio frequency units. Each radio frequency unit is coupled to the signal processing unit and is independently operable to receive signals and transmit signals using an antenna such that the radio may transmit a signal through one of the radio frequency units while simultaneously receiving the transmitted signal using another of the radio frequency units. The signal processing unit may be implemented, for example, using a digital signal processor or an application-specific integrated circuit.

In some implementations, the signal processing unit includes an analog-to-digital converter and a digital-to-analog converter associated with each of the radio frequency units. The signal processing unit is operable to perform probeless transmit/receive compensation, for example, by successively transmitting a known signal using each of the radio frequency units while receiving the known signal using the other radio frequency units.

In another general aspect, a transmit/receive compensation method includes, for each antenna in an antenna array, transmitting a known signal using the antenna while receive the transmitted signal using the other antennas in the antenna array, and calculating transmit/receive compensation based on the ratios between received signals and transmitted signals. Calculating transmit/receive compensation based on the ratios between received signals and transmitted signals may be performed by determining a transfer function Hᵢⱼ for signals transmitted by antenna j and received by antenna i for each pair of antennas in the antenna array, determining a system function Gₘₙ using the ratio of transfer functions Hₘₙ and Hₙₘ for each pair of antennas in the antenna array, and, for each antenna x in the antenna array, calculating transmit/receive compensation by summing the system function G_{xy} for each antenna y in the antenna array.

In some implementations, determining a transfer function Hᵢⱼ includes determining the ratio of signal received by antenna i to the known signal transmitted using antenna j. In implementations where transmit/receive compensation occurs concurrently with other communications, determining a transfer function Hᵢⱼ for signals transmitted by antenna j and received by antenna i includes correlating the signal received by antenna i with the signal transmitted by antenna j to determine a set of weights, applying the set of weights to the signal received by antenna i to identify the signal received from antenna j, determining a transfer function Hᵢⱼ using a ratio of the signal received from antenna i and the signal transmitted by antenna j, and applying another set of weights to the signal received by antenna i to identify another received signal.

In another general aspect, a probeless transmit/receive compensation method for an antenna array having n antennas includes transmitting a known signal from an identified antenna i in the antenna array to each of the remaining n−1 antennas in the antenna array, successively transmitting a known signal from each of the remaining n−1 antennas in the antenna array to the identified antenna i, and determining a transmit/receive compensation weight hᵢ for the identified antenna i using the equation, hᵢ=Gᵢ₁+Gᵢ₂+ . . . +Gᵢₙ, where functions Gᵢⱼ are system functions that are calculated based on ratios of transmitted and received signals.

In some implementations, the system functions Gᵢⱼ are calculated using the equation, Gᵢⱼ=Hᵢⱼ/Hⱼᵢ, where Hᵢⱼ is a transfer function. The transfer function Hᵢⱼ may be calculated using the equation, Hᵢⱼ=Xᵢⱼ/Y, where Xᵢⱼ is the response on antenna i to the signal transmitted by antenna j and Y is the known signal transmitted by antenna j.

The details of one or more implementations are set forth in the accompanying drawings and the description below. Other features and advantages will be apparent from the description and drawings, and from the claims.

### DESCRIPTION OF DRAWINGS

FIG. 1 is a diagram of a radio communication system.

FIG. 2 is a radio implementing probeless transmit/receive compensation when using spatial processing techniques to improve performance.

FIG. 3A is a diagram of a desired antenna radiation pattern in a beamforming implementation.

FIG. 3B is a diagram of a resulting antenna radiation pattern without transmit/receive compensation.

FIGS. 4A, 4B, and 4C are diagrams of desired antenna radiation patterns for singles transmitted to or received from each of three devices in a multi-device beamforming system.

FIG. 4D shows the desired combination of the component signals of FIGS. 4A-4C to simultaneously communicate with multiple devices.

FIG. 4E shows a potential variation in a multi-device beamforming system without transmit/receive compensation.

FIG. 5A is a block diagram of a radio transmission system using spatial processing techniques.

FIG. 5B is a block diagram of a radio transmission system using transmit/receive compensation when employing spatial processing techniques.

FIG. 6 is a flowchart of a process to calculate transmit/receive compensation in a radio communication system.

FIG. 7 is a schematic diagram of a radio communication system receiving a noise signal at an angle θ.

FIG. 8 is a radio having multiple antennas providing independent control of transmit/receive timing to implement probeless transmit/receive compensation.

FIG. 9 is a block diagram of the radio frequency (RF) component of the radio shown in FIG. 8.

FIG. 10 is a block diagram of the digital component of the radio shown in FIG. 8.

### DETAILED DESCRIPTION

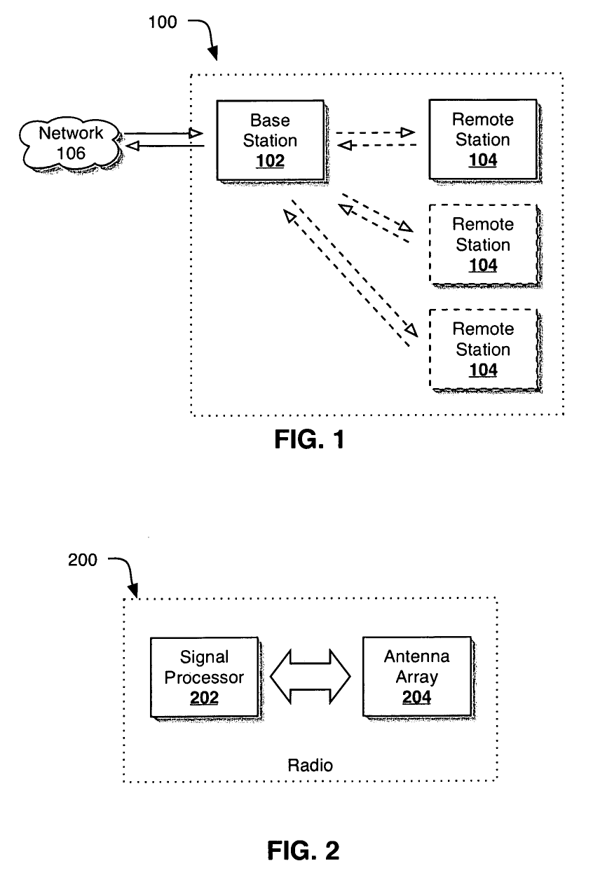

Referring to FIG. 1, a radio communication system 100 comprises a base station 102 operable to communicate with multiple remote stations 104. The base station 102 is coupled to a network 106 such that the base station 102 can transfer information between the network 106 and the remote stations 104. The radio communication system 100 may be used to provide wireless services, such as, for example, wireless metropolitan area networks, wireless local area networks, wireless video-on-demand, and/or wireless voice services.

For example, the radio communication system 100 may be used to implement a wireless local area network (WLAN) based on the IEEE 802.11 standard. In such an implementation, the base station 102 serves as an access point or as a router, connecting one or more remote stations 104 to a network 106, which can be a local area network (LAN) or a wide area network (WAN), such as the Internet. The remote stations 104 typically are laptop or desktop computers configured with wireless network interface cards.

The base station 102 is a hardware device that facilitates radio frequency (RF) communications with remote stations 104. The RF communications is typically two-way (with the base station 102 and remote station 104 transmitting and receiving information from one another). To facilitate two-way RF communications, the base station 102 includes at least one antenna and a signal processing unit. The signal processing unit typically includes components to filter and amplify signals, to convert signals between analog and digital, and to interpret and process received data.

The base station 102 and remote stations 104 may be implemented using conventional electronic design and manufacturing techniques using application-specific integrated circuits and/or commercial off-the-shelf components. Portions of the implementations may be carried out in software-configured digital signal processors (DSPs) or general-purpose microprocessors.

One way to improve performance of a radio communication system 100 is use smart antenna technology—processing signals transmitted and/or received to reduce potential interference and/or to increase gain. A single omni-directional antenna transmits and receives radio signals equally well in any direction. However, in many radio communication systems, it is desirable to maximize performance across communication link(s) between a base station 102 and one or more remote stations 104. When multiple antennas are used together, signal processing techniques may be employed to modify the effective radiation characteristics of the antennas such that antennas become more directional, increasing gain in desired directions, and nulling potential interference. Smart antenna systems include any use of signal processing to vary the effective radiation characteristics of multiple antennas in the transmission or reception of radio communication signals.

When using a smart antenna system, signal processing techniques are employed to vary phase and/or amplitude for each antenna that is used (which may include all available antennas or a subset of the available antennas). Because these amplitude and phase variations determine the antenna radiation pattern, they affect the overall performance of a radio communication system using smart antenna technology. A variety of factors may vary relative transmission and/or reception characteristics between the antennas in a smart antenna system, such as, for example, thermal noise, differing feed line lengths, and component variations. These variations may distort the desired antenna radiation pattern, causing performance degradation.

Spatial processing is used to increase signal gain in a particular direction and null interfering signals received from other directions. To adjust the directional characteristics of an antenna system, a series of complex weights may be applied to the signals transmitted or received by each antenna. These complex weights may be calculated when signals are received such that transmitted signals will have maximum gain in the direction of a corresponding received signal. However, it is common for transmit and receive paths to differ. Therefore, if the receive path is used to calculate complex weights for the transmit path, transmitted signals are likely to vary in amplitude and phase from the desired and intended transmission, causing undesirable variations in radiation patterns. These variations may degrade system performance; therefore, it is desirable to provide a technique to compensate for differences between transmit and receive paths such that spatial processing can accurately and effectively modify transmission characteristics to improve overall system performance.

One technique that may be used for transmit/receive compensation is to add a probe path to each antenna in an array such that the probe path may be used to detect and compensate for transmission differences. The techniques described herein provide an alternative to the use of a probe path in performing transmit/receive compensation, thus reducing implementation costs and potentially removing a single point of system failure.

Referring to FIG. 2, a radio 200 including a signal processor 202 coupled to an antenna array 204 may be used as either a base station 102 or as a remote station 104. The radio 200 implements spatial processing techniques to improve the reception and/or transmission of signals by the radio 200. In an exemplary implementation, the radio 200 is a base station 102 providing wireless network services to one or more remote stations 104. The radio 200 uses conventional beamforming techniques to compute complex weights based on signals received by the radio 200. The complex weights may be applied to transmitted signals to modify the phase and/or gain of the signal to be transmitted by each antenna of the antenna array 204. Because transmit and receive paths may differ, probeless transmit/receive compensation is used to improve system performance.

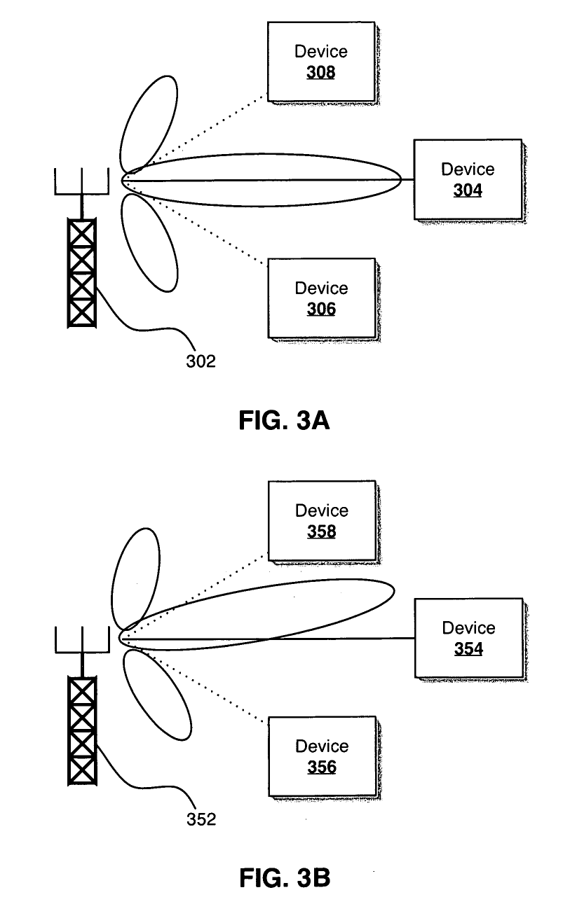

FIG. 3A illustrates a desired radiation pattern in a single-user beamforming system. Using conventional beamforming techniques, an antenna array 302 is used to transmit information to device 304. Complex weights are calculated to vary the radiation pattern of antenna array 302 such that maximum gain is in the direction of device 304. The direction of device 304 may be determined using signal processing techniques on one or more signals received from device 304. In addition, the antenna array 302 uses a radiation pattern with nulls in the direction of devices 306 and 308. With transmit beamforming, the transmitted signal is attenuated in the direction of devices 306 and 308 to reduce potential interference. If corresponding weights are applied to received signals, the nulls in radiation pattern of antenna array 302 would reduce possible interference received from the direction of devices 306 and 308. In addition, by varying transmitted signals to improve gain in desired directions and attenuate signals in other directions, multipath interference may be reduced.

In this implementation, signal processing techniques are used to vary the radiation pattern of signals transmitted by antenna array 302. For example, using conventional beamforming techniques, a radio 200 receiving signals through antenna array 302 may calculate a set of complex weights that may be used to vary the phase and/or amplitude of signals transmitted by the some or all of the elements of the antenna array 302. Because receive and transmit paths may differ, calculated complex weights may not perform as expected.

FIG. 3B shows an example of a transmission made without compensating for transmit and receive path differences. In this example, variations in phase and/or amplitude caused the radiation pattern to vary slightly from the desired pattern shown in FIG. 3A. Here, maximum signal gain is not directed towards device 354 as desired. Instead, maximum gain is shifted towards device 358 and a side-lobe is shifted towards device 356. This deviation may cause increased interference in the direction of devices 356 and 358, and decreased signal strength in the direction of device 354. While these deviations may decrease performance with a single user, the effect becomes much greater in a multi-user system.

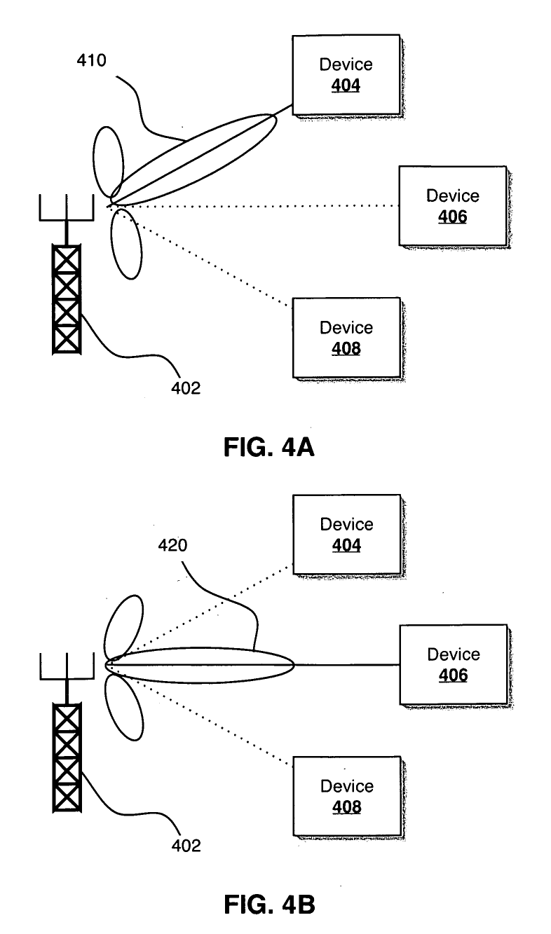

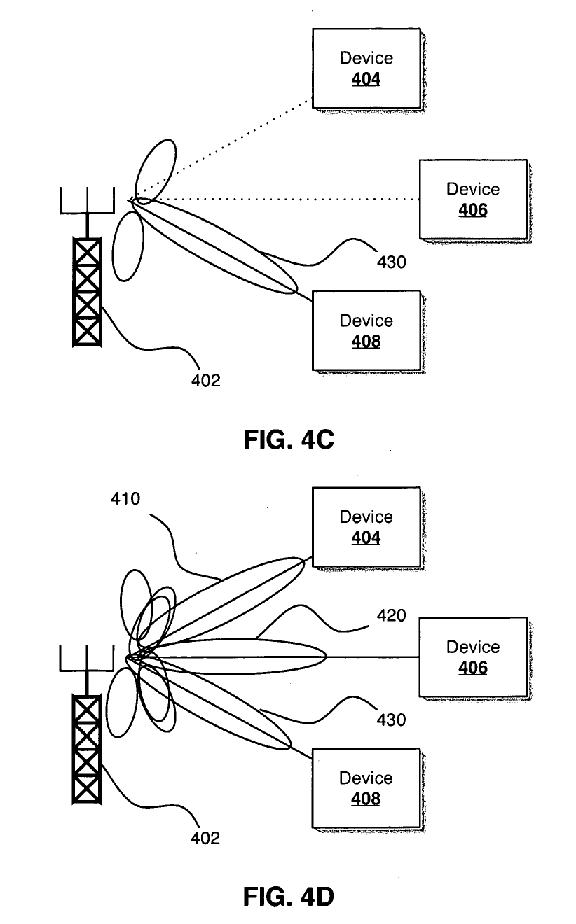

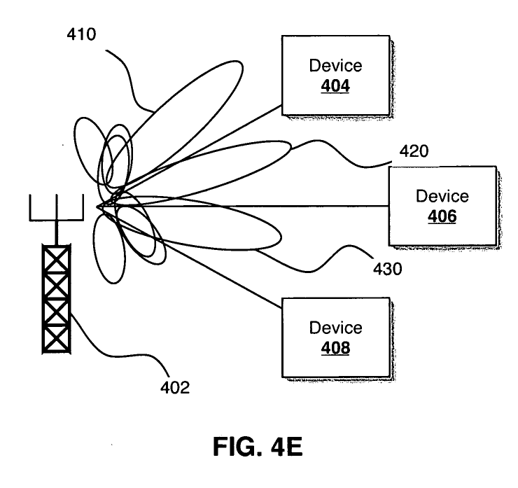

Referring to FIG. 4A, a multi-user system provides communication between a base station antenna 402 and various devices 404, 406, and 408. By using spatial processing techniques (e.g., beamforming), a set of complex weights may be calculated to steer maximum gain towards a particular device (in this case device 404). Conventional spatial processing techniques vary the radiation pattern of transmitted signals with maximum gain focused in one general direction; however, radiation patterns usually include one or more side-lobes whereby the signal is transmitted in a direction other than that of the intended target of communication. In this example, a set of complex weights is calculated to produce radiation pattern 410 with maximum gain focused towards device 404.

Referring to FIGS. 4B and 4C, complex weights also may be calculated to steer signals towards devices 406 and 408 by producing radiation patterns 420 and 430. In a radio communication system that communicates with a single device at a time, each of the radiation patterns 410, 420, and 430 may be separately applied when communicating with the corresponding intended device 404, 406, or 408. However, the radiation patterns also may be combined such that the radio communication may simultaneously communicate with multiple devices. For example, when transmitting to multiple devices simultaneously, a radio system can apply each of the three sets of complex weights generating radiation patterns 410, 420, and 430 to a different transmission signal. The resulting signals may be combined and transmitted to each intended device 404, 406, and 408. Because signals between the antenna 402 and each of the devices 404, 406, and 408 are processed using weights to generate radiation patterns 410, 420, and 430, communications between the antenna 402 and a single device should not interfere with communications with the other devices. Accordingly, it is even possible for each of the devices 404, 406, and 408 to simultaneously use the same frequencies without inter-device interference.

FIG. 4D shows the result of combining radiation patterns 410, 420, and 430. Each radiation pattern may be applied to the same signal or to different signals, such that information may be simultaneously communicated to multiple devices. In this example, an antenna 402 communicates with devices 404, 406, and 408 by applying complex weights to produce antenna radiation patterns 410, 420, and 430. When antenna 402 is simultaneously receiving information from devices 404, 406, and 408, a signal processor may successively apply the weights corresponding to the radiation patterns 410, 420, and 430 to isolate the desired communication signal.

For example, if antenna 402 is excited by signals from devices 404 and 408, then an attached radio can isolate the desired signal by applying the complex weights corresponding to the intended device. To receive a signal from device 404, signal processing techniques may be used on a signal received by antenna 402 to apply complex weights corresponding to radiation pattern 410. This effectively amplifies signals received from the direction of device 404 and filters out signals received from other directions. Similarly, signal processing can be used to isolate communications from other devices.

A multi-user radio system using spatial processing, such as, for example, beamforming, can transmit communication signals to various devices 404, 406, and/or 408 by determining one or more communication signals to transmit, applying appropriate signal processing to each communication signal, combining the processed signals together, and transmitting the combined signal. For example, a radio using beamforming to transmit a first communication signal to device 404 and a second communication signal to device 406 can apply complex weights corresponding to radiation pattern 410 to the first communication signal and complex weights corresponding to radiation pattern 420 to the second communication signal. The resulting two communication signals may be combined and transmitted using antenna 402. Because the complex weights vary radiation patterns, the first signal should be primarily transmitted in the direction of device 404 and the second signal should be primarily transmitted in the direction of device 406.

If both communication signals use the same frequency, they could potentially interfere with one another; however, so long as the spatial processing sufficiently isolates the two signals, such communication is possible. Often a system using spatial processing will calculate certain parameters (such as the complex weights in beamforming) based on received signals. These parameters then may be used to control transmitted signals. Because transmit and receive paths may differ, variations in phase and amplitude are possible.

FIG. 4E shows an example transmission with phase and amplitude shifted due to differences in reception and transmission paths. With even slight variations, transmission radiation patterns may be shifted such that leakage occurs between devices causing SINR (signal to interference plus noise ratio) degradation as one or more of devices 404, 406, and 408 receives a portion of the signals intended for another device.

FIGS. 4A through 4E illustrate potential performance degradation caused by amplitude and/or phase distortions. For example, a radio communication system 200 employing spatial processing techniques to transmit information using an antenna array 204 may encounter amplitude and/or phase distortion when spatial processing parameters for transmissions are calculated using received signals because of transmit/receive path differences. A technique to compensate for these differences is described below.

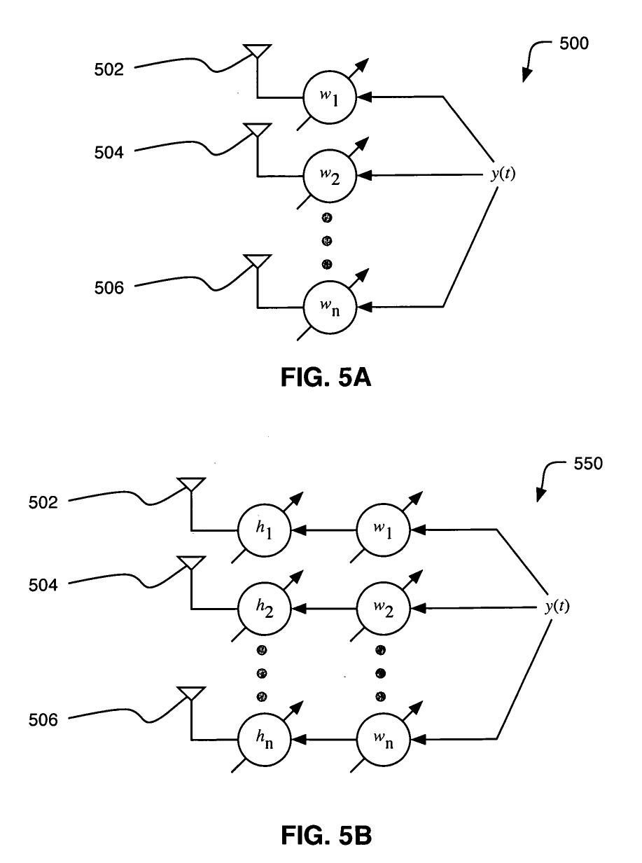

Referring to FIG. 5A, a typical radio communication system 500 using spatial processing techniques applies a set of complex weights (i.e., w₁, w₂, . . . wₙ) to an output signal y(t) to provide increased spectral efficiency. In some implementations, radio communication system 500 performs transmit beamforming by calculating a set of complex weights (w₁, w₂, . . . wₙ) with each weight corresponding to an antenna (502, 504, or 506). The antennas (502, 504, and 506) operate together as an antenna array that may include any number of antennas. The complex weights (w₁, w₂, . . . wₙ) are applied to an output signal y(t) and the resulting signals are transmitted by the antennas 502, 504, and 506. Because the complex weights (w₁, w₂, . . . wₙ) are calculated based on received signals, the transmission path may introduce some unwanted variations in phase and/or gain.

Referring to FIG. 5B, radio communication system 550 compensates for transmit/receive path differences by applying a set of complex weights (h₁, h₂, . . . hₙ) to output signals. In this implementation, the complex weights (h₁, h₂, . . . hₙ) each correspond to a particular antenna 502, 504, or 506. The complex weights (h₁, h₂, . . . hₙ) may be applied before or after any additional processing is performed or a series of complex weights for a particular antenna may be combined together to form a single weight that performs the desired signal processing as well as any necessary transmit/receive compensation. In this implementation, an output signal y(t) is processed by applying complex weights (w₁, w₂, . . . wₙ) to implement spatial processing techniques and by applying complex weights (h₁, h₂, . . . hₙ) to compensate for transmit/receive path variations.

The antennas 502, 504, and 506 may be implemented such that they are independently controlled (i.e., each antenna 502, 504, and 506 is independently switched between transmit and receive modes). By providing independent control, the radio 500 may calculate complex weights (h₁, h₂, . . . hₙ) using the techniques described below.

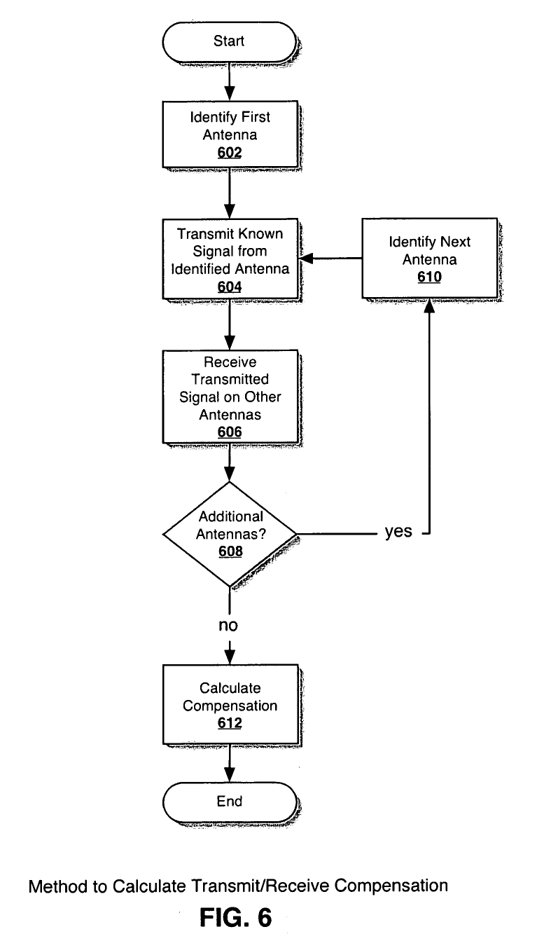

Referring to FIG. 6, transmit/receive compensation may be calculated for an array of antennas by transmitting a known signal sequentially using each of the antennas in the array. While one antenna is used to transmit the known signal, the remaining antennas receive the signal. A set of compensation weights may be calculated based on the received signals. FIG. 6 shows one implementation of a method to perform transmit/receive compensation. In this implementation, the process begins by identifying a first antenna (602) to be used to transmit. The first antenna is selected from a group of antennas that will be used in the transmit/receive compensation. This group of antennas may include some or all of the antennas in an antenna array. Once the first antenna is identified, that antenna is used to transmit a known signal (604). This transmission is received by each of the other antennas in the group (606) and information is kept that will be used to calculate a set of transmit/receive compensation weights.

The process continues by determining whether additional antennas remain (608). If additional antennas remain, the next antenna is identified (610) and used to transmit a known signal (604). Once each antenna has been used to transmit a known signal, then the transmit/receive compensation weights may be calculated. To calculate transmit/receive compensation (612), the system first calculates a set of transfer functions, which are the ratio of received signals to transmitted signals, for each pair of transmit/receive antennas by dividing the received signal by the expected signal. The transfer functions are used to calculate a set of system functions by determining the ratio of transfer functions between each pair of antennas. These system functions then determine a set of compensation weights (h₁, h₂, . . . hₙ).

In one implementation, transmit/receive compensation is calculated for a three-antenna system (Ant1, Ant2, and Ant3). The differences between the gain and phase variations between the transmit and receive paths may cause performance degradation. To compensate for these variations, we transmit a known signal Y from antenna Ant1 and receive this signal on the other antennas. In this implementation, the known signal Y is a frequency domain representation of an OFDM (orthogonal frequency division multiplexing) signal. To simplify matters, assume for purposes of example that Y is the single OFDM tone 1. Any known value may be chosen for Y For example, if Y were a rotated BPSK (binary phase shift keying) signal, then Y could be represented by −1−i or 1+i. It may be advantageous to choose a known signal with a constant modulus. One way to create such a signal in an OFDM implementation is to fill in tones with constant amplitudes of, for example, −1 and 1 and have the choice of −1 and 1 be psuedo-random but known across the FFT. By making the choice of −1 of 1 (with some constant scale factor) random, the crest factor of the signal in the time domain is smaller and hence less chance of clipping the digital to analog converter or saturating the amplifier. Similarly, the phase of each tone in the known signal may be varied to help the crest factor.

As the known signal Y is transmitted, it is affected by the following: (1) the transmit transfer function, T(n), of the corresponding antenna; (2) the transfer function, C(n), of the air; (3) the receive transfer function, R(n), of the receiving antenna; and (4) noise, N(n), resulting from thermal noise, time error, or any other source. To calculate transmit/receive compensation weights, the known signal Y is transmitted by antenna Ant1 and received by the other antennas (Ant2 and Ant3). The received signal X_{pq} is the measured response on antenna p given the signal transmitted on antenna q. In this example, the following responses are measured when transmitting on antenna Ant1 and receiving on antenna Ant2 and when transmitting on antenna Ant1 and receiving on antenna Ant3, respectively:
X₂₁=C(1)*R(2)*T(1)*Y+N(1)=39.01+39.02i; and
X₃₁=C(3)*R(3)*T(1)*Y+N(2)=69.04+32.98i.

Next, the known signal Y is transmitted from antenna Ant2 and received by the other antennas with the following responses:
X₁₂=C(1)*R(1)*T(2)*Y+N(3)=−49.95+9.90i; % Tx on Ant2, Rx on Ant1
X₃₂=C(2)*R(3)*T(2)*Y+N(4)=−39.98+19.60i; % Tx on Ant2, Rx on Ant3

Finally, the known signal Y is transmitted from antenna Ant3 and received by the other antennas with the following responses:
X₁₃=C(3)*R(1)*T(3)*Y+N(S)=100.01−19.70i; % Tx on Ant3, Rx on Ant1
X₂₃=C(2)*R(2)*T(3)*Y+N(6)=64.03−7.90i; % Tx on Ant3, Rx on Ant2

Each of the responses is divided by the transmitted signal Y to determine the corresponding transfer function as follows:
H₂₁=X₂₁/Y=39.01+39.02i;
H₃₁=X₃₁/Y=69.04+32.98i;
H₁₂=X₁₂/Y=−49.95+9.90i;
H₃₂=X₃₂/Y=−39.98+19.60i;
H₁₃=X₁₃/Y=100.01−19.70i; and
H₂₃=X₂₃/Y=64.03−7.90i;

Next, the transfer functions are used to calculate each system function G_{pq} which is a ratio of transmit and receive transfer functions, G_{pg}=H_{pq}/H_{qp}. In this example, this results in the following system functions:
G₁₁=1;
G₂₂=1;
G₃₃=1;
G₁₂=H₁₂/H₂₁=−0.51317+0.76708i;
G₂₁=H₂₁/H₁₂=1/G₁₂=−0.60249−0.90059i;
G₁₃=H₁₃/H₃₁=1.0685−0.79574i;
G₃₁=H₃₁/H₁₃=1/G₁₃=0.60201+0.44835i;
G₂₃=H₂₃/H₃₂=−1.3693−0.4737i; and
G₃₂=H₃₂/H₂₃=1/G₂₃=−0.65223+0.22563i.

These system functions are then used to calculate transmit/receive compensation weights (h₁, h₂, . . . hₙ) as follows:
h₁=G₁₁+G₁₂+G₁₃=1.5553−0.028661i;
h₂=G₂₂+G₂₁+G₂₃=−0.97181−1.3743i; and
h₃=G₃₃+G₃₁+G₃₂=0.94978+0.67399i.

When a signal is transmitted using antennas Ant1, Ant2, or Ant3, the corresponding compensation weights h₁, h₂, and h₃ may be applied to compensate for variations in gain and/or phase caused by transmit/receive path differences.

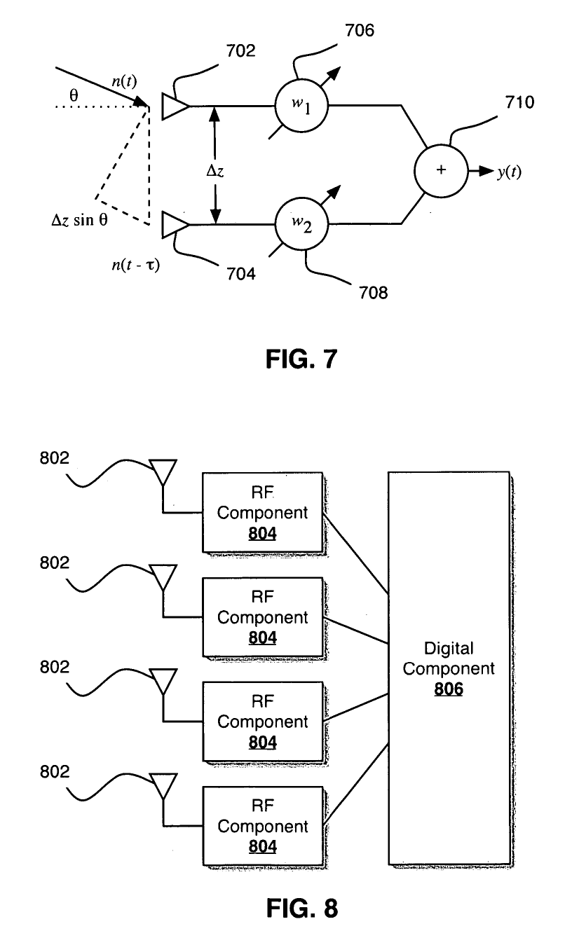

Referring to FIG. 7, the techniques discussed above may be used to calculate a set of complex weights to compensate for transmit/receive path variations; however, this compensation is frequency-dependent. Consider, for example, a radio receiving signals through a two-antenna array. An interfering signal n(t) originating from a direction of θ arrives at a first antenna 702 and then arrives at a second antenna 704 τ seconds later, where τ=(Δz/c) sin θ and c is propagation speed of the signal. Null steering may be used to cancel out the interfering signal n(t) by calculating a set of complex weights 506 and 508. In this implementation, the output y(t) is a function of the interfering signal n(t) as follows:
y(t)=w₁n(t)+w₂n(t−τ).

Taking the Fourier Transform, the frequency domain representation is:
Y(ω,t)=N(ω,t)[w₁+w₂e^{-jωτ}].

If the interference is a stationary signal, where the frequency spectra N(ω,t) varies slowly over time relative to ω, and narrowband with a center frequency of f₀, N(ω,t) is zero everywhere except where ω equals ω₀. To perfectly cancel the signal using null steering, weights are chosen such that w₁=w₂e^{-ω}^{₀}^{τ}. With these weights, the frequency domain representation of the signal y(t) becomes Y(ω,t)=0.

Unfortunately, if the signal is not truly narrowband, the response on each antenna changes over frequency. As is the case with OFDM, if too many tones are grouped with a set of weights, the weights result in less than perfect cancellation. For a stationary environment N(ω,t)=N(ω), the weights result in a transfer function:

$$H ( ω ) = \frac{Y ( ω )}{N ( ω )} = {w}_{1} [ 1 - {ⅇ}^{- j ( ω - {ω}_{0} ) τ} ] .$$

If |w₁|²=1, the output power |H(ω)|² becomes,
|H(ω)|²={2−2 cos[τ(ω−ω₀]}.

The output has infinite attenuation, as expected, at the center frequency, but decreases rapidly as we move away from the center frequency of the interfering signal. The frequencies away from the center frequency where the weights were calculated will only be slightly attenuate and not completely canceled. Just as null steering is frequency dependent, transmit/receive compensation is similarly frequency dependent. Accordingly, it is useful to apply calculated weights to a narrow group of transmission frequencies. Field experiments suggest that for an OFDM system, the tones should be grouped up to no more that 50-100 kHz chunks. Beyond approximately 100 kHz, the antenna response begins to vary.

Similarly, transmit/receive compensation may be time-dependent. As temperature, channel, and noise characteristics change over time, the effectiveness of compensation weights is likely to vary. It may be useful to periodically recalculate weights to ensure effective transmit/receive compensation. How often transmit/receive compensation should be performed is implementation-dependent. If temperature is stable, it may be sufficient to recalculate weights twice per day; however, in most cases, it is sufficient to recalculate transmit/receive compensation weights once every ten minutes. In high-performance radio communication systems where it is critical to maintain high signal-to-noise ratios, it may be useful to recalculate transmit/receive compensation every 20 seconds.

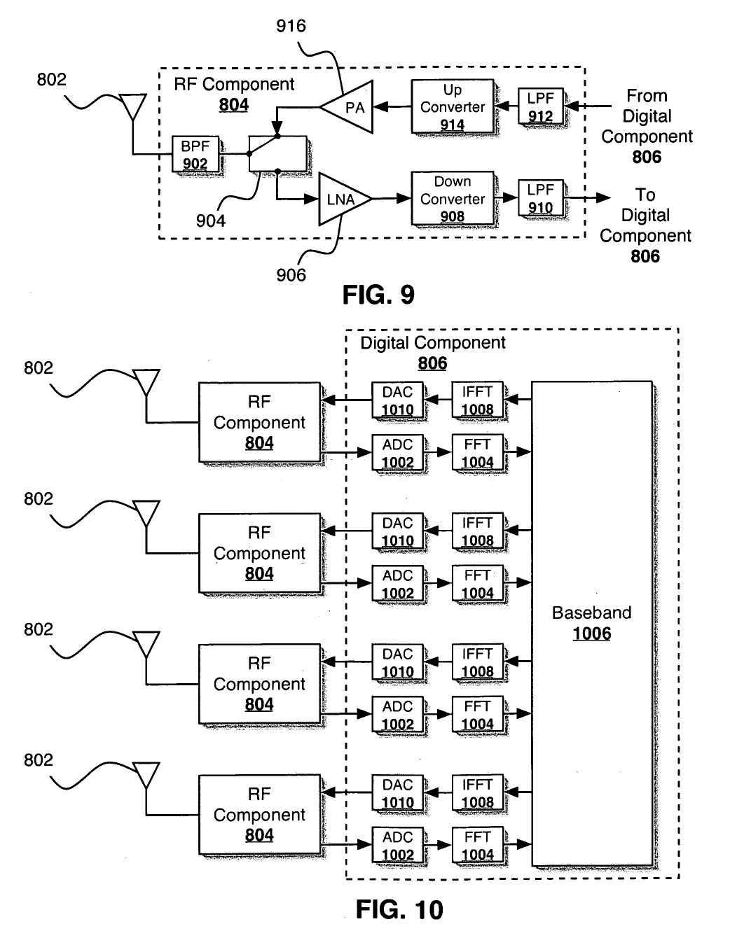

Referring to FIG. 8, a wireless broadband base station 800 includes multiple antennas 802, an RF component 804 associated with each antenna, and at least one digital component 806. Though the base station 800 may employ as few as two antennas 802, a typical implementation will usually employ a greater number (e.g., 4, 12, 16, or 32 antennas 802). By using multiple antennas, the digital component 806 can implement spatial processing techniques, varying the signals sent to or received from each of the RF components 804 to improve performance. In an implementation of a broadband wireless radio implementing transmit beamforming, a base station radio includes 16 antennas 802 with each of the antennas 802 associated with an RF component 804 to process, such as the RF component 804 described below with respect to FIG. 9. The RF components 804 are coupled to the digital component 806 which may be implemented using an application-specific integrated circuit (ASIC) or a digital signal processor (DSP) or other processing device.

In this implementation, the RF components 804 provide two modes: transmit and receive. In transmit mode, a signal to be transmitted is received from the digital component 806, up converted to a transmit frequency or frequencies, amplified, and then transmitted. Various filtering also may be implemented to improve the quality of the transmitted signal. For example, the signal received from the digital component 806 is typically modulated at a baseband frequency. This signal may be passed through a low-pass filter to prevent amplication of any extraneous artifacts. Once the signal has been up converted and amplified, it may be passed through a band-pass filter to prevent any out-of-band transmissions.

Similarly, the RF component 804 may be placed in a receive mode such that signals received by antenna 802 are passed through a low-noise amplifier, then down converted to baseband frequency, and then passed to the digital component 806 for processing. Various filtering may be added to improve performance, such as, for example, a band-pass filter may be applied to signals received through antenna 802 to prevent the processing of out-of-band signals, and a low-pass filter may be used on the down converted signal. In some implementations, the RF component may include components to convert signals between digital and analog representations; however, in this implementation, the signal conversion takes place in the digital component 806.

In this design, each of the antennas 802 may be independently controlled such that one or more of the antennas 802 may be transmitting while the remaining antennas 802 are receiving. This allows transmit/receive compensation to be accomplished without interrupting client communication and without introducing unnecessary delays. For example, transmit/receive compensation may be performed by transmitting a known signal using one of the antennas 802. The remaining antennas 802 receive the signal transmitted by the first antenna 802 as well as any signals transmitted by other devices. Using spatial processing techniques, a set of weights can be calculated to isolate the known signal and perform transmit/receive compensation as discussed above. In addition, one or more sets of weights may be applied to identify signals transmitted by other devices.

Referring to FIG. 9, an exemplary implementation of RF component 804 includes a band pass filter (BPF) 802 coupled to the antenna 802 and used on both that transmit and receive paths to filter out signals outside the frequency or frequencies of interest. The BPF 802 is coupled to a switch 904 that selectively enables the receive path or the transmit path to use the antenna 802. The switch 904 is coupled to the receive path where signals pass through a low noise amplifier (LNA) 906, then a down converter 908, and, finally, a low pass filter (LPF) 910, before being passed to the digital component 806. When transmitting, signals are received from the digital component 806, passed through a low pass filter (LPF) 912, converted to transmission frequency or frequencies by up converter 914, and passed through a power amplifier (PA) 916. The transmit path is coupled to antenna 802 using switch 904 such that the amplified signal is passed through BPF 902 and then transmitted using antenna 802.

Referring to FIG. 10, an exemplary implementation of the digital component 806 of FIG. 8 receives signals from multiple RF components 804. To process the received signals, the digital component includes one or more analog-to-digital converters (ADC) 1002. In this implementation, orthogonal frequency division multiplexing (OFDM) to provide increased bandwidth utilization while supporting multiple users. To process OFDM signals, this implementation of digital component 806 includes a fast Fourier transform (FFT) component 1004. The transformed digital signal is then passed to baseband 1006 for processing. Baseband 1006 is typically implemented using a digital signal processor. To transmit signals, the baseband 1006 sends signals through an inverse fast Fourier transform 1008 and a digital to analog converter (DAC) 1010. The converted signals are then passed through RF component 804 to be transmitted using antenna 802.

A number of implementations have been described. Nevertheless, it will be understood that various modifications may be made without departing from the spirit and scope of the invention. Accordingly, other implementations are within the scope of the following claims.

What is claimed is:

1. A radio communication system comprising:
multiple antennas; and
a processor coupled to the multiple antennas, the processor including a probeless transmit/receive compensation component enabling the radio communication system to compensate for variations in transmit and receive paths while transmitting a signal.

2. The radio communication system of claim 1 wherein the multiple antennas form an antenna array.

3. The radio communication system of claim 1 wherein the processor is a digital signal processor.

4. The radio communication system of claim 1 wherein each of the multiple antennas is coupled to the processor by a transmit path that is independent from the transmit path used by other antennas and by a receive path that is independent from the receive path used by other antennas.

5. The radio communication system of claim 4 wherein the probeless transmit/receive compensation component of the processor is operable to calculate a set of complex weights to compensate for variations in transmit and receive paths by periodically iterating through each of the multiple antennas, transmitting a known signal using one of the multiple antennas, while receiving the transmitted known signal using the remaining antennas; and calculating a set of compensation parameters based on received signals.

6. The radio communication system of claim 1 wherein the processor coupled to the multiple antennas is operable to transmit and receive orthogonal frequency division multiplexing (OFDM) signals.

7. The radio communication system of claim 6 wherein the OFDM signals include multiple tones and the transmit/receive compensation component of the processor is operable to calculate a separate set of complex weights for groups of OFDM tones.

8. A radio comprising:
a signal processing unit; and
at least two radio frequency units, each radio frequency unit coupled to the signal processing unit and independently operable to receive signals and transmit signals using an antenna such that the radio may transmit a signal through one of the radio frequency units while simultaneously receiving the transmitted signal using another of the radio frequency units.

9. The radio of claim 8 wherein the signal processing unit is a digital signal processor.

10. The radio of claim 8 wherein the signal processing unit is an application-specific integrated circuit.

11. The radio of claim 8 wherein the signal processing unit includes an analog-to-digital converter and a digital-to-analog converter associated with each of the radio frequency units.

12. The radio of claim 8 wherein the signal processing unit is operable to perform probeless transmit/receive compensation.

13. The radio of claim 12 wherein the signal processing unit is operable to perform probeless transmit/receive compensation by successively transmitting a known signal using each of the radio frequency units while receiving the known signal using the other radio frequency units.

14. A transmit/receive compensation method comprising:
for each antenna in an antenna array, transmitting a known signal using the antenna while receive the transmitted signal using the other antennas in the antenna array; and
calculating transmit/receive compensation based on the ratios between received signals and transmitted signals.

15. The method of claim 14 wherein calculating transmit/receive compensation based on the ratios between received signals and transmitted signals includes:
for each pair of antennas in the antenna array, determining a transfer function Hᵢⱼ for signals transmitted by antenna j and received by antenna i;
for each pair of antennas in the antenna array, determining a system function Gₘₙ using the ratio of transfer functions Hₘₙ and Hₙₘ; and
for each antenna x in the antenna array, calculating transmit/receive compensation by summing the system function G_{xy} for each antenna y in the antenna array.

16. The method of claim 15 wherein determining a transfer function Hᵢⱼ includes determining the ratio of signal received by antenna i to the known signal transmitted using antenna j.

17. The method of claim 15 wherein determining a transfer function Hᵢⱼ for signals transmitted by antenna j and received by antenna i includes:
correlating the signal received by antenna i with the signal transmitted by antenna j to determine a set of weights;
applying the set of weights to the signal received by antenna i to identify the signal received from antenna j;
determining a transfer function Hᵢⱼ using a ratio of the signal received from antenna j and the signal transmitted by antenna j; and
applying another set of weights to the signal received by antenna i to identify another received signal.

18. A probeless transmit/receive compensation method comprising:
in an antenna array having n antennas, transmitting a known signal from an identified antenna i in the antenna array to each of the remaining n−1 antennas in the antenna array;
successively transmitting a known signal from each of the remaining n−1 antennas in the antenna array to the identified antenna i;
determining a transmit/receive compensation weight hᵢ for the identified antenna i using the equation, hᵢ=Gᵢ₁+Gᵢ₂+ . . . +Gᵢₙ, where functions Gᵢⱼ are system functions that are calculated based on ratios of transmitted and received signals.

19. The probeless transmit/receive compensation method of claim 18 wherein the system functions Gᵢⱼ are calculated using the equation, Gᵢⱼ=Hᵢⱼ/Hⱼᵢ, where Hᵢⱼ is a transfer function.

20. The probeless transmit/receive compensation method of claim 19 wherein the transfer function Hᵢⱼ is calculated using the equation, Hᵢⱼ=Xᵢⱼ/Y, where Xᵢⱼ is the response on antenna i to the signal transmitted by antenna j and Y is the known signal transmitted by antenna j.
